(19) United States
(12) Patent Application Publication
(10) Pub. No.: US 2018/0227377 A1
(43) Pub. Date: Aug. 9, 2018

(54) EXPOSURE AND APPLICATION BEHAVIOR SETTING BASED ON DO NOT DISTURB STATE

(71) Applicant: MICROSOFT TECHNOLOGY LICENSING, LLC, Redmond, WA (US)

(72) Inventors: Anant Trivedi, Seattle, WA (US); Ankit Gupta, Redmond, WA (US); Hemant Sharma, Seattle, WA (US); Dipak Sarjerao Pawar, Bellevue, WA (US)

(73) Assignee: MICROSOFT TECHNOLOGY LICENSING, LLC, Redmond, WA (US)

(21) Appl. No.: 15/423,601

(22) Filed: Feb. 3, 2017

(51) Int. Cl. H04L 29/08

(52) U.S. Cl. CPC H04L 67/24; H04L 67/26; H04L 67/22; H04L 67/141; H04L 67/306; H04L 67/18; H04L 67/325

(57) ABSTRACT

Variety of approaches to propagate a do not disturb state are described. A hosted service initiates operations to propagate the do not disturb state upon determining a user's state to be the do not disturb state based on receiving a direct user input or an inference from user associated data. The do not disturb state is exposed to an application consumed by a user and other application consumed by other user. The hosted service provides the application and the other application. A behavior of the application is configured based on the do not disturb state. Upon expiration of the do not disturb state, the behavior of the application is reverted.

### BACKGROUND

Information exchange have changed processes associated with work and personal environments. Automation and improvements in processes have expanded scope of capabilities offered for personal and business consumption. With the development of faster and smaller electronics, execution of mass processes at cloud systems have become feasible. Indeed, applications provided by data centers, data warehouses, data workstations have become common features in modem personal and work environments. Such systems execute a wide variety of applications ranging from enterprise resource management applications to hosted service(s).

Increasingly, cloud storage providers are utilized for providing and/or managing content and applications across multiple clients, where the cloud storage providers have engines that automatically distribute the content and applications to the clients. However, there are currently significant gaps when managing device and/or application state automatically. Productivity resources are unnecessarily consumed to manage state(s) individually on device(s) and application(s) consumed by a user. Lack of relevant distributed state configuration technologies lead to poor t management of productivity resources when attempting to change state associated with device(s) and application(s).

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to propagation of a do not disturb state. A hosted service, according to embodiments, may initiate operations to propagate a do not disturb state upon determining a user's state to be the do not disturb state based on receiving a direct user input or an inference from user associated data. The do not disturb state may be exposed to an application consumed by a user and other application consumed by other user. The application and the other application may be provided by the hosted service. A behavior of the application may be configured based on the do not disturb state. Upon an expiration of the do not disturb state, the behavior of the application may be reverted.

These and other features and advantages will he apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 is a conceptual diagram illustrating examples of propagating a do not disturb state, according to embodiments;

FIG. 2 is another conceptual diagram illustrating examples of propagating a do not disturb state, according to embodiments;

FIG. 3 is a display diagram illustrating example components of a hosted service that propagates a do not disturb state, according to embodiments;

FIG. 4 is a display diagram illustrating components of a scheme to propagate a do not disturb state, according to embodiments

FIG. 5 is a display diagram illustrating interaction(s) with incoming communication(s) based on a propagated do not disturb state, according to embodiments;

FIG. 6 is a simplified networked environment, where a system according to embodiments may be implemented;

FIG. 7 is a block diagram of an example computing device, which may be used to propagate a do not disturb state, according to embodiments and

FIG. 8 is a logic flow diagram illustrating a process for propagating a do not disturb state, according to embodiments.

### DETAILED DESCRIPTION

As briefly described above, a hosted service may propagate a do not disturb state. In an example scenario, the hosted service may determine a user's state to be the do not disturb state based on receiving a direct user input or an inference from user associated data. The inference may be determined based on a user behavior analyzed from the user associated data. The user behavior may be analyzed from a schedule of the user, communication(s) associated with the user, a location of the user, and/or external factors.

Next, the do not disturb state may be exposed to an application consumed by a user and other application consumed by other user. The application and the other application may be provided by the hosted service. The application may be rendered by a client device associated with the user. The other application may be rendered by other client device associated with the other user. A behavior of the application may be configured based on the do not disturb state. For example, the application may reject an incoming communication, provide a silent notification to the user, provide a muted notification to the user, and/or provide a dimmed notification to the user upon receiving the incoming communication. Upon an expiration of the do not disturb state, the behavior of the application may be reverted.

In the following detailed description, references are made to the accompanying drawings that form a part hereof, and in which are shown by way of illustrations, specific embodiments, or examples. These aspects may be combined, other aspects may be utilized, and structural changes may be made without departing from the spirit or scope of the present disclosure. The following detailed description is therefore not to he taken in a limiting sense, and the scope of the present invention is defined by the appended claims and their equivalents.

While some embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Some embodiments may be implemented as a computer-implemented process (method), a computing system, or as an article of manufacture, such as a computer program product or computer readable media. The computer'program product may be a computer storage medium readable by a computer system and encoding a computer program comprises instructions lix causing a computer or computing system to perform example process(es). The computer-readable storage medium is a computer-readable memory device. The computer-readable storage medium can for example be implemented via one or more of a volatile computer memory, a non-volatile memory, a hard drive, a flash drive, a floppy disk, or a compact disk, and comparable hardware media.

Throughout this specification, the term “platform” may be a combination of software and hardware components for propagating a do not disturb state. Examples of platforms include, but are not limited to, a hosted service executed over a plurality of servers, an application executed on a single computing device, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example operations is provided below.

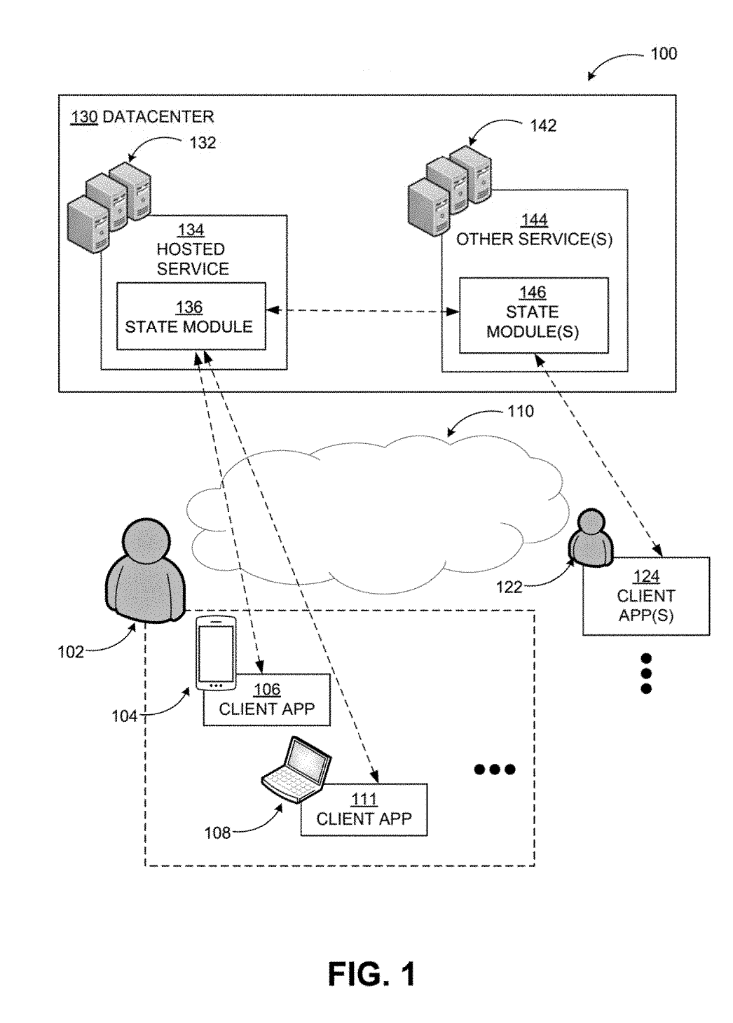

FIG. 1 is a conceptual diagram illustrating example of propagating a do not disturb state, according to embodiments.

In a diagram 100, a datacenter may incorporate a number of server(s) such as a server cluster 132 and a server cluster 142. Each of the server clusters (132 and 142) may provide service(s) and application(s) (communicated through a network 119) for rendering by client devices (104 and 108) and other entity(s).

In an example scenario, a user 102 may consume a client application 106 provided by a hosted service 134 and rendered by a client device 104. An example of the client device 104 may include a smartphone. The user may also consume a client application 111 provided by the hosted service 134 and rendered by a client device 108. An example of the client device 108 may include a mobile computer such as a laptop. The user 102 may wish to propagate control and/or limit interactions with the client applications (106 and 110) by employing a do not disturb state. In an example embodiment, the user 102 may propagate a do not disturb state to client applications (106 and 110) through a state module 136 of the hosted service 134.

The state module 136 may include a special component of the hosted service 134 with unique features to manage/control interactions associated with the do not disturb state between the hosted service 134 and the client applications (106 and 110). The state module 136 may configure a behavior of the client applications (106 and 110) in response to detecting a do not disturb state set by the user 102 at the hosted service 134. Alternatively, an inference module of the hosted service 134 may infer the do not disturb state from user associated data (such as a schedule of the user 102).

The state module 136 may also interact with the state module(s) 146 of the other service(s) 144 to configure a behavior of client application(s) 124 provided by the other service(s) 144 (the other service(s) may be executed by the server cluster 142). The client application(s) 124 may be consumed by other user 122. In an example scenario, the user 102 may include a supervisor who may wish to configure a do not disturb state for client applications (106 and 110) to minimize (or prevent) interactions with the client device(s) (104 and 108) such as work provided devices during off work hours.

The supervisor may also be authorized to propagate the do not disturb state to client application(s) 124 consumed by worker(s) such as the user 122 to prevent (or limit) interaction between the subordinate(s) and the client application(s) 124 such as work related application(s). The state module 136 may interact with the state module(s) 146 to propagate the do not disturb state to client application(s) 124. In a similar scenario, a parent may propagate a do not disturb state from the state module 136 to client application(s) 124 consumed by a child through the state module(s) 146 of other service(s) 144.

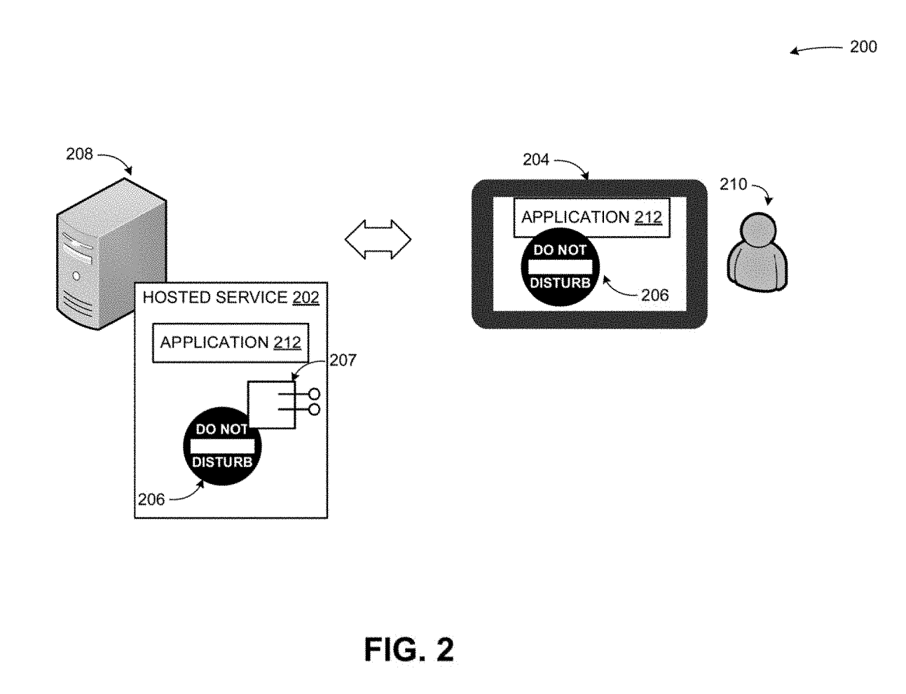

FIG. 2 is another conceptual diagram illustrating examples of propagating ado not disturb state, according to embodiments.

In a diagram 200, a server 208 may execute a hosted service 202. The server 208 may include a physical server providing service(s) and/or application(s) to client devices. A service may include an application performing operations in relation to a client application and/or a subscriber, among others. The server 208 may include and/or is part of a workstation, a data warehouse, a data center, and/or a cloud based distributed computing source, among others.

The server 208 may execute the hosted service 202. An example of the hosted service 202 may include a communication service, and/or a productivity service, among others. The hosted service 202 may initiate operations to propagate a do not disturb state upon determining a user's state to be the do not disturb state based on receiving a direct user input or an inference from user associated data. The inference may be determined based on a user behavior analyzed from the user associated data. The user behavior may be analyzed from a schedule of the user 210, communication(s) associated with the user 210, a location of the user 210, and/or external factors. The external factors may include weather, traffic, and/or a nature based event, among others.

Next, the do not disturb state may be exposed to an application 212 consumed by the user 210. An application programming interface (API) 207 may expose the do not disturb state 206 to the application 212. The API 207 may be a component of the hosted service 202. Alternatively the API 207 may be provided by a third party provider to manage interactions between the hosted service 202 and the application 212 in relation to the do not disturb state 206.

The application 212 may be provided by the hosted service 202. The application 212 may be rendered by a client device 204 associated with the user 210. A behavior of the application 212 may be configured based on the do not disturb state 206. For example, the application 212 may reject an incoming communication, provide a silent notification to the user 210, provide a muted notification to the user 210, and/or provide a dimmed notification to the user 210 upon receiving the incoming communication. Upon an expiration of the do not disturb state 206, the behavior of the application 212 may be reverted.

The server 208 may communicate with the client device 204 through a network. The network may provide wired or wireless communications between network nodes such as the client device 204 and/or the server 208, among others. Previous example(s) to propagate the do not disturb state 206 are not provided in a limiting sense. Alternatively, the hosted service 202 may propagate the do not disturb state 206 as a desktop application, a workstation application, and/or a server application, among others. The application 212 may also include a client interface of the hosted service 202.

The user 210 may interact with the application 212 with a keyboard based input, a mouse based input, a voice based input, a pen based input, and/or a gesture based input, among others. The gesture based input may include one or more touch based actions such as a touch action, a swipe action, and/or a combination of each, among others.

While the example system in FIG. 2 has been described with specific components including the server 208, the hosted service 202, embodiments are not limited to these components or system configurations and can be implemented with other system configuration employing fewer or additional components.

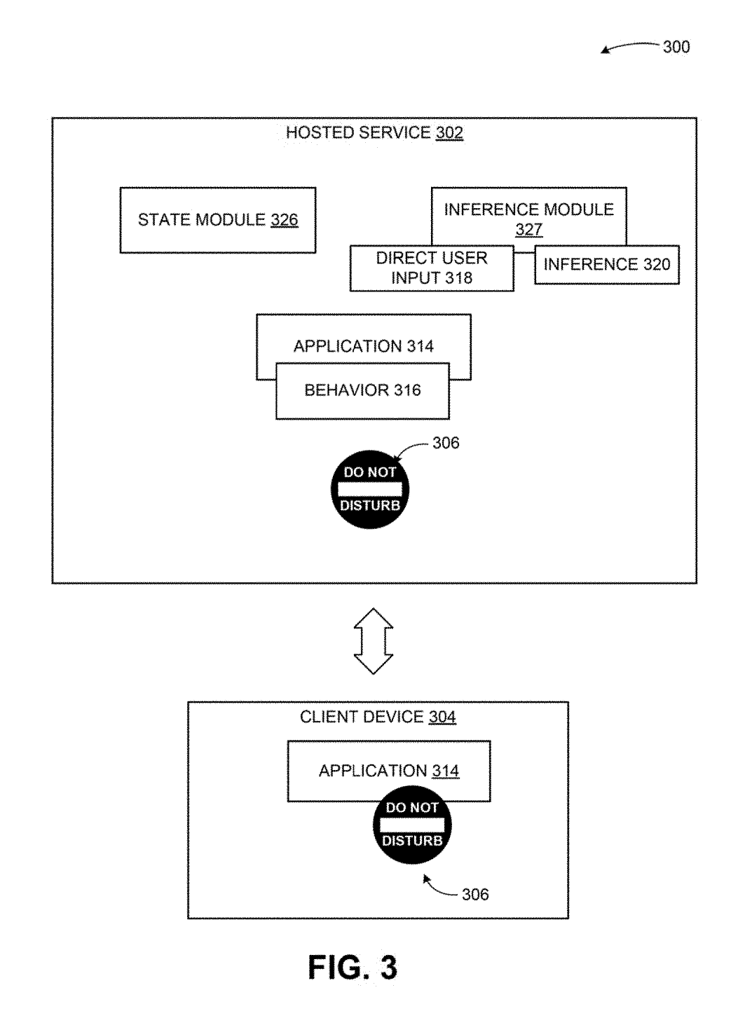

FIG. 3 is a display diagram illustrating example components of a hosted service that propagates a do not disturb state, according to embodiments.

As illustrated in diagram 300, an inference module of the hosted service 302 may determine a user's state to be a do not disturb state 306 based an receiving a direct user input 318 or an inference 320. The direct user input 318 may include a notification and/or a selection by the user to inform the hosted service 302 to configure the user's state to the do not disturb state 306. Alternatively, the inference module may determine a user behavior associated with personal and work activities. The personal and work activities may be identified by analyzing a schedule of the user, communication(s) associated with the user, a location of the user, and/or external factors, among others. The external factors may include a weather, a traffic, and/or a nature based event, among others.

Furthermore, the inference module 327 may determine the user's state based on the inference 320 by analyzing data from a client device 304 rendering the application 314 provided by the hosted service 302. The data from the client device (such as a time of day) may be used to evaluate whether one or more criteria associated with the do not disturb state are met. For example, the client device 304 may report a time of day at a location associated with the user as an evening period associated with a sleep cycle. In such a scenario, the inference module 327 may infer the do not disturb state based on the data from the client device and set the do not disturb state 306 as the user's state.

A state module 326 of the hosted service 302 may expose the do not disturb state 306 to the application 314 consumed by a user (associated with the client device 304). The application 314 may be provided by the hosted service 302. A behavior 316 of the application 314 may be configured based on the do not disturb state 306. For example, the behavior 316 pray include a rejection of an incoming communication, a transmission of a silent notification to the user, a transmission of a muted notification to the user, and/or a rendering of a dimmed notification to the user, among others. Furthermore, the state module 126 may reject an invitation to schedule a meeting.

Upon detecting an expiration of the do not disturb state 306, the state module 326 may revert the behavior 316 of the application. The state module 326 may store a previous state of the behavior 316 of the application 314 which may be used to revert the application 314.

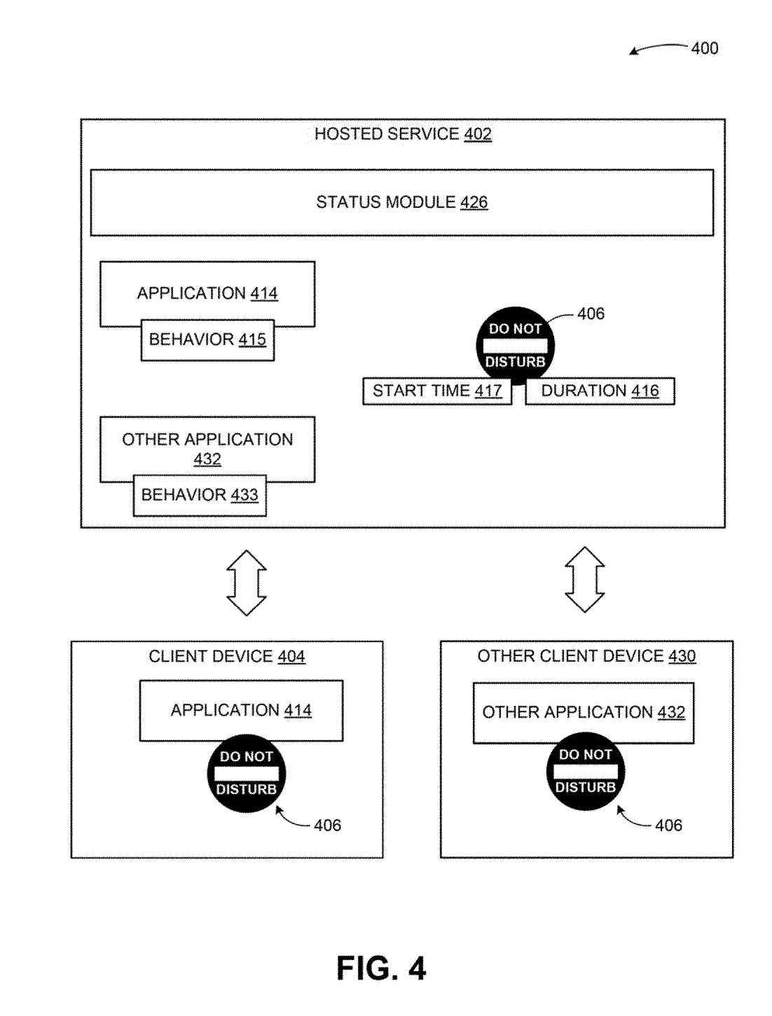

FIG. 4 is a display diagram illustrating components of a scheme to propagate a do not disturb state, according to embodiments.

As shown in a diagram 400, a state module 426 of a hosted service 402 may configure a behavior 415 of an application 414 based on a do not disturb state 406. The do not disturb state 406 may include a start time 417 and a duration 416 which may be provided by a user associated with the application 414 or inferred from information associated with the user or a client device 404 associated with the user.

Furthermore, the hosted service 402 may provide other application 432 for rendering by other client device 430. The other application 432 may be associated with the user (as the user may interact with the other application 432 through the client device 430). The state module 426 may propagate the do not disturb state 406 to the other application 432 by configuring a behavior 433 of the other application 432 based on the do not disturb state 406. If the do not disturb state 406 includes the start time 417 and the duration 416, upon an expiration of the do not disturb state 406, the behavior 433 of the other application 432 may be reverted.

Furthermore, the do not disturb state 406 may be exposed to other hosted service(s) such that a behavior of an application provided by the other hosted service(s) may be configured based on the do not disturb state 406 of the user. For example, a supervisor may set the do not disturb state 406 with the hosted service 402. The state module 426 may propagate the do not disturb state 406 to other service(s) to configure a behavior of application(s) associated with subordinate(s) of the supervisor (such as during an off work time period). A parent may also propagate the do not disturb state 406 to an application associated with a child through the state module 426 of the hosted service 402. Similarly, behavior of application(s) associated with the user hosted by other service(s) may also be configured by the state module 426 when the state module 426 propagates the do not disturb state 406 through the other service(s).

The behavior of the application 414 and the other application 432 (while configured with the do not disturb state 406 may include a rejection based behavior in which an incoming communication and/or an invitation tier an event may be rejected (which may or may not be sent back to the sender and/or the invitee). Furthermore, the incoming communication and/or the invitation may be stored when received during the duration 416 of the do not disturb state 406. The user may also be notified about the incoming communication and/or the invitation upon an expiration of the do not disturb state 406. An example of the incoming communication may include an audio communication, a video communication, an online conference, a text message, an email, a desktop sharing session, and/or a data sharing session, among others.

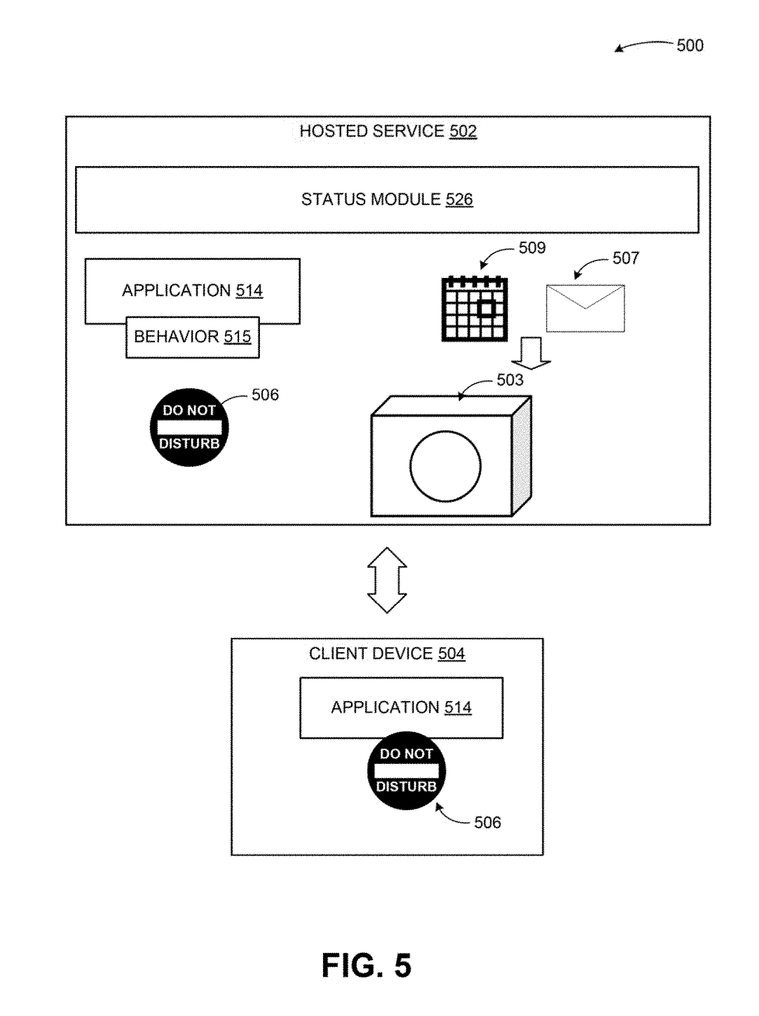

FIG. 5 is a display diagram illustrating interaction(s) with incoming communication(s) based on a propagated do not disturb state, according to embodiments.

As shown in a diagram 500, a state module 526 of a hosted service 502 may configure a behavior 515 of an application 514 (provided by the hosted service 502) based on a do not disturb state 506. A client device 504 may render the application 514 to a user (who may have initiated the do not disturb state 506).

The state module 526 may further configure the behavior 515 of the application 516 based on an exception 503 to the do not disturb state 506. For example, the state module 526 may receive a direct user input that defines the exception 503 to the do not disturb state 506. Alternatively, a user behavior determined from the user associated data may be used to infer the exception 503. The exception 503 may also be configured to persist while the do not disturb state 506 endures. However, the exception 503 may also be configured with a duration different than the do not disturb state 506.

In an example scenario, an incoming communication 507 may be allowed to be provided to the user based on the exception 503 during a duration of the do not disturb state 506. The exception may allow the incoming communication 507 because a sender of the communication may be detected as a family member, a supervisor, and/or a designated sender by the user (within the exception 503).

Similarly, a meeting invitation 509 may be allowed to be provided to the user based on the exception 503 during a duration of the do not disturb state 506. The exception may allow the meeting invitation 509 because an invitee of the meeting invitation may be detected as a supervisor and/or a designated invitee by the user (within the exception 503).

Furthermore, the state module 526 may determine a reason for the do not disturb state 506. The reason for the do not disturb state 506 may be exposed alone, with the do not disturb state 506 to the application 514. Alternatively, the exception 503 may be determined for the do not disturb state based on the reason of the do not disturb state 506. For example, the reason for the do not disturb state 506 may be determined based on an analysis of content of the incoming communication 507 or a scheduled event (such as the meeting invitation 509) associated with the user. In an example scenario, the content of the incoming message may describe a time period in which the user is identified as in the do not disturb state 506 (such as a sleep, in a doctor's appointment, in vacation, and/or at a recital, among others). In such a scenario, the time period and associated activity may be exposed as the reason for the do not disturb state 506. Similarly, a detected scheduled event such as a vacation may be exposed as the reason for the do not disturb state 506.

As discussed above, the hosted service may be employed to propagate the do not disturb state. An increased performance and efficiency improvement with the hosted service 134 may occur as a result of propagating the do not disturb state from the hosted service to application(s) consumed by the user or other application(s) consumed by other user(s) for whom the user is authorized to set the do not disturb state. Additionally, propagating the do not disturb state among application(s) consumed by the user and other application(s) consumed by other user(s), by the hosted service 134, may reduce processor load, increase processing speed, conserve memory, and reduce network bandwidth usage.

Embodiments, as described herein, address a need that arises from a lack of efficiency to propagate the do not disturb state. The actions/operations described herein are not a mere use of a computer, but address results that are a direct consequence of software used as a service offered to large numbers of users and applications.

The example scenarios and schemas in FIG. 1 through 5 are shown with specific components, data types, and configurations. Embodiments are not limited to systems according to these example configurations. Propagating the do not disturb state may be implemented in configurations employing fewer or additional components in applications and user interfaces. Furthermore, the example schema and components shown in FIG. 1 through 5 and their subcomponents may be implemented in a similar manner with other values using the principles described herein.

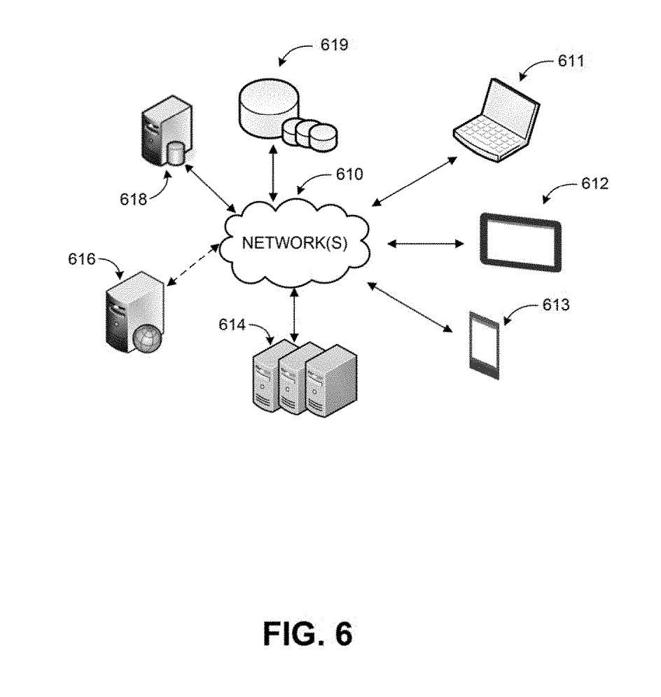

FIG. 6 is an example networked environment, where embodiments may be implemented. A hosted service configured to propagate a do not disturb state may be implemented via software executed over one or more servers 614 such as a hosted service. The platform may communicate with client applications on individual computing devices such as a smart phone 613, a mobile computer 612, or desktop computer 611 (‘client devices’) through network(s) 610.

Client applications executed on any of the client devices 611-613 may facilitate communications via application(s) executed by servers 614, or on individual server 616. A hosted service may determine a user's state to he the do not disturb state based on receiving a direct user input or an inference from user associated data. The do not disturb state may be exposed to an application consumed by a user and other application consumed by other user. The application and the other application may be provided by the hosted service. A behavior of the application may be configured based on the do not disturb state. Upon expiration of the do not disturb state, the behavior of the application may be reverted. The hosted service may store data associated with the do not disturb state in data store(s) 619 directly or through database server 618.

Network(s) 610 may comprise any topology of servers, clients, Internet service providers, and communication media. A system according to embodiments may have a static or dynamic topology. Network(s) 610 may include secure networks such as an enterprise network, an unsecure network such as a wireless open network, or the Internet, Network(s) 610 may also coordinate communication over other networks such as Public Switched Telephone Network (PSTN) or cellular networks. Furthermore, network(s) 610 may include short range wireless networks such as Bluetooth or similar ones. Network(s) 610 provide communication between the nodes described herein. By way of example, and not limitation, network(s) 610 may include wireless media such as acoustic, RF, infrared and other wireless media.

Many other configurations of computing devices, applications, data sources, and data distribution systems may be employed to propagate the do not disturb state. Furthermore, the networked environments discussed in FIG. 6 are for illustration purposes only. Embodiments are not limited to the example applications, modules, or processes.

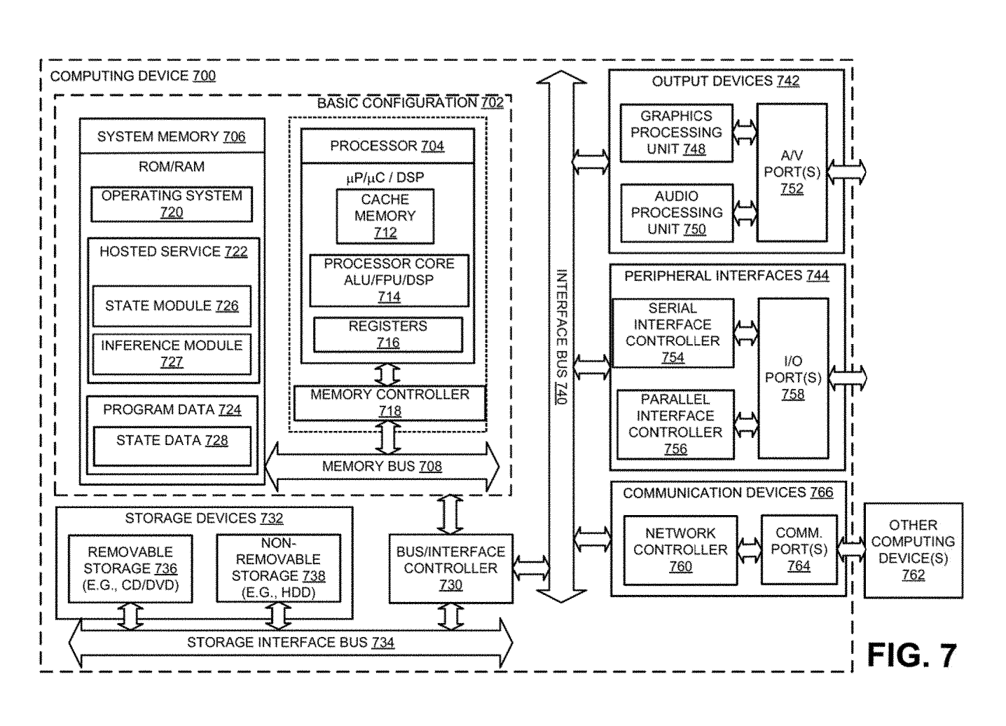

FIG. 7 is a block diagram of an example computing device, which may be used to propagate a do not disturb state, according to embodiments.

For example, computing device 700 may be used as a server, desktop computer, portable computer, smart phone, special purpose computer, or similar device. In an example basic configuration 702, the computing device 700 may include one or more processors 704 and a system memory 706. A memory bus 708 may be used for communication between the processor 704 and the system memory 706. The basic configuration 702 may be illustrated in FIG. 7 by those components within the inner dashed line.

Depending on the desired configuration, the processor 704 may be of any type, including but not limited to a microprocessor (μP), a microcontroller (μC), a digital signal processor (DSP), or any combination thereof. The processor 704 may include one more levels of caching, such as, a level cache memory 712, one or more processor cores 714, and registers 716. The example processor cores 714 may (each) include an arithmetic logic unit (ALU), a floating point unit (FPU), a digital signal processing core (DSP Core), or any combination thereof. An example memory controller 718 may also be used with the processor 704, or in some implementations, the memory controller 718 may be an internal part of the processor 704.

Depending on the desired configuration, the system memory 706 may be of any type including but not limited to volatile memory (such as RAM), non-volatile memory (such as ROM, flash memory, etc.), or any combination thereof. The system memory 706 may include an operating system 720, a hosted service 722, and a program data 724. The hosted service 722 may include components such as a state module 726 and an inference module 727. The state module 726 and the inference module 727 may execute the processes associated with the hosted service 722. The inference module 727 may determine a user's state to be the do not disturb state based on receiving a direct user input or an inference from user associated data. The state module 726 may expose the do not disturb state to an application consumed by a user and other application consumed by other user. The application and the other application may be provided by the hosted service. A behavior of the application may be configured based on the do not disturb state. Upon expiration of the do not disturb state, the behavior of the application may be reverted.

Input to and output out of the hosted service 722 may be transmitted through a communication module associated with the computing device 700. An example of the communication module may include a communication device 766 that may be communicatively coupled to the computing device 700. The communication module may provide wired and/or wireless communication. The program data 724 may also include, among other data, state data 728, or the like, as described herein. The state data 728 may include a do not disturb state, a start time, a duration, among others.

The computing device 700 may have additional features or functionality, and additional interfaces to facilitate communications between the basic configuration 702 and any desired devices and interfaces. For example, a bus/interface controller 730 may be used to facilitate communications between the basic configuration 702 and one or more data storage devices 732 via a storage interface bus 734. The data storage devices 732 may be one or more removable storage devices 736, one or more non-removable storage devices 738, or a combination thereof. Examples of the removable storage and the non-removable storage devices may include magnetic disk devices, such as flexible disk drives and hard-disk drives (HDDs), optical disk drives such as compact disk (CD) drives or digital versatile disk (DVD) drives, solid state drives (SSDs), and tape drives, to name a few. Example computer storage media may include volatile and nonvolatile, removable, and non-removable media implemented in any method or technology for storage of information, such as computer-readable instructions, data structures, program modules, or other data.

The system memory 706, the removable storage devices 736 and the non-removable storage devices 738 are examples of computer storage media. Computer storage media includes, but is not limited to, RAM, ROM, EEPROM, flash memory or other memory technology, CD-ROM, digital versatile disks (DVDs), solid state drives, or other storage, magnetic cassettes, magnetic tape, magnetic disk storage or other magnetic storage devices, or any other medium which may be used to store the desired information and which may be accessed by the computing device 700. Any such computer storage media may be part of the computing device 700.

The computing device 700 may also include an interface bus 740 for facilitating communication from various interface devices (for example, one or more output devices 742, one or more peripheral interfaces 744, and one or more communication devices 766) to the basic configuration 702 via the bus/interface controller 730. Some of the example output devices 742 include a graphics processing unit 748 and an audio processing unit 750, which may be configured to communicate to various external devices such as a display or speakers via one or more A/V ports 752. One or more example peripheral interfaces 744 may include a serial interface controller 754 or a parallel interface controller 756, which may be configured to communicate with external devices such as input devices (for example, keyboard, mouse, pen, voice input device, touch input device, etc.) or other peripheral devices (for example, printer, scanner, etc.) via one or more I/O ports 758. An example of the communication device(s) 766 includes a network controller 760, which may be arranged to facilitate communications with one or more other computing devices 762 over a network communication link via one or more communication ports 764. The one or more other computing devices 762 may include servers, computing devices, and comparable devices.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

The computing device 700 may be implemented as a pan of a general purpose or specialized server, mainframe, or similar computer, which includes any of the above functions. The computing device 700 may also be implemented as a personal computer including both laptop computer and non-laptop computer configurations. Additionally, the computing device 700 may include specialized hardware such as an application-specific integrated circuit (ASIC), a field programmable gate array (FPGA), a programmable logic device (PLD), and/or a free form logic on an integrated circuit (IC), among others.

Example embodiments may also include methods to propagate a do not disturb state. These methods can be implemented in any number of ways, including the structures described herein. One such way may be by machine operations, of devices of the type described in the present disclosure. Another optional way may be for one or more of the individual operations of the methods to be performed in conjunction with one or more human operators performing some of the operations while other operations may be performed by machines. These human operators need not be collocated with each other, but each can be only with a machine that performs a portion of the program. In other embodiments, the human interaction can be automated such as by pre-selected criteria that may be machine automated.

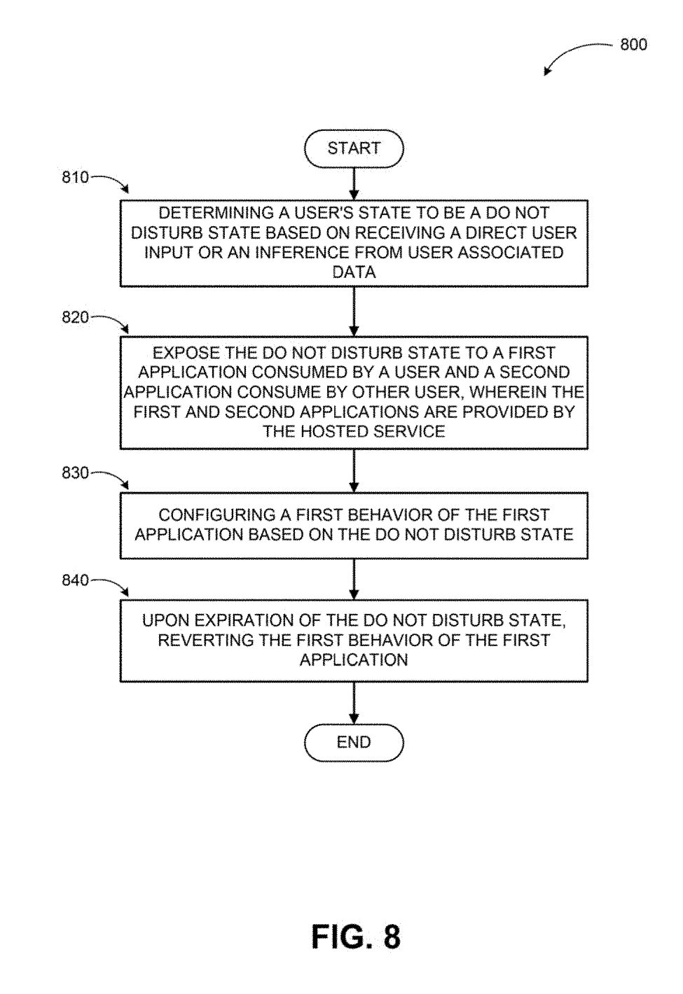

FIG. 8 is a logic flow diagram illustrating a process for propagating a do not disturb state, according to embodiments. Process 800 may be implemented on a computing device, such as the computing device 700 or another system.

Process 800 begins with operation 810, where the hosted service may determine a user's state to be the do not disturb state based on receiving a direct user input or an inference from user associated data. The inference may be determined based on a user behavior analyzed from the user associated data. The user behavior ma be analyzed from a schedule of the user, communication(s) associated with the user, a location of the user, and/or external factors, among others.

Next, the do not disturb state may be exposed to an application consumed by a user and other application consumed by other user at operation 820. The application and the other application may be provided by the hosted service. The application may be rendered by a client device associated with the user. The other application may be rendered by other client device associated with the other user. At operation 830, a behavior of the application may be configured based on the do not disturb state. For example, the application may reject an incoming communication, provide a silent notification to the user, provide a muted notification to the user, and/or provide a dimmed notification to the user upon receiving the incoming communication. At operation 840, upon expiration of the do not disturb state, the behavior of the application may be reverted.

The operations included in process 800 is for illustration purposes. Propagating a do not disturb state may be implemented by similar processes with fewer or additional steps, as well as in different order of operations using the principles described herein. The operations described herein may be executed by one or more processors operated on one or more computing devices, one or more processor cores, specialized processing devices, and/or general purpose processors, among other examples.

In some examples, a method executed on a computing device to propagate a do not disturb state is described. The method includes determining a user's state to be a do not disturb state based on receiving a direct user input or an inference from user associated data, exposing the do not disturb state to a first application consumed by a user and a second application consumed by other user, where the first and second applications are provided by the hosted service, configuring a first behavior of the first application based on the do not disturb state, and upon expiration of the do not disturb state, reverting the first behavior of the first application.

In other examples, the method further includes configuring a second behavior of the second application based on the do not disturb state of the user and upon expiration of the do not disturb state, reverting the second behavior of the second application. The method further includes exposing the do not disturb state to other hosted service such that a third behavior of a third application provided by the other hosted service is configured based on the do not disturb state of the user. Configuring the first behavior of the first application includes one or more of rejecting an incoming communication, providing a silent notification to the user, providing a muted notification to the user, and providing a dimmed notification to the user upon receiving the incoming communication. Configuring the first behavior of the first application includes rejecting an invitation to schedule a meeting during a duration of the do not disturb state.

In further examples, configuring the first behavior of the first application includes storing an incoming communication or an invitation to schedule a meeting received during a duration of the do not disturb state and notifying the user regarding the incoming communication or the invitation to schedule the meeting upon an expiration of the do not disturb state. The incoming communication includes one of: an audio communication, a video communication, an online conference, a text message, an email, a desktop sharing session, and a data sharing session. Determining the user's state to be the do not disturb state based on the inference from the user associated data includes determining a user behavior associated with personal and work activities and inferring the do not disturb state and a duration of the do not disturb state based on the determined user behavior. Determining the user behavior associated with the personal and work activities includes analyzing a schedule of the user, one or more communications associated with the user, a location of the user, and one or more external factors. Determining the user's state to be the do not disturb state based on the inference from the user associated data includes analyzing data from a client device rendering the first application.

In some examples, a server configured to propagate a do not disturb state is, described. The server includes a communication module configured to facilitate communication between a hosted service and an application provided by the hosted service on which the do not disturb state is to be configured, a memory configured to store instructions, and a processor coupled to the memory and the communication module. The processor executes the hosted service in conjunction with the instructions stored in the memory. The hosted service includes an inference module and a state module. The inference module is configured to determine a user's state to be a do not disturb state based on receiving a direct user input or an inference from user associated data. The state module is configured expose the do not disturb state to the application consumed by a user, where the application is provided by the hosted service, determine an exception that interrupts the do not disturb state during a duration of the do not disturb state, configure a behavior of the application based on the do not disturb state and the exception, and upon expiration of the do not disturb state, revert the behavior of the application.

In other examples, the inference module is further configured to determine the exception with one or more operations to receive other direct user input associated with the exception. The inference module is further configured to determine the exception with one or more operations to determine a user behavior from the user associated data and infer the exception for the do not disturb state and the duration of the do not disturb state based on the user behavior. The state module is further configured to configure the behavior of the application based on the exception with one or more operations to allow an incoming communication to be provided to the user based on the exception, where a sender of the communication is detected as one or more of a family member, a supervisor, and a designated sender by the user.

In further examples, the state module is further configured to configure the behavior of the application based on the exception with one or more operations to allow a meeting invitation during the duration of the do not disturb state to be scheduled based on the exception, where an invitee of the meeting is detected as one or more of a supervisor and a designated invitee by the user. The state module is further configured to determine a reason for the do not disturb state and one of: expose the reason for the do not disturb state along with the do not disturb state, and determine the exception for the do not disturb state based on the reason of the do not disturb state. The state module is further configured to determine the reason for the do not disturb state based on an analysis of content of one or more of an incoming communication and a scheduled event associated with the use. The state module is further configured to revert the behavior of the application upon an expiration of the do not disturb state with an operation to expose an end of do not disturb state upon the expiration of the do not disturb state, or expose a duration of the do not disturb state along with the do not disturb state.

In some examples, a computing device configured to execute a client application that receives a do not disturb state is described. The computing device includes a memory configured to store instructions and a processor coupled to the memory. The processor executes a client application in conⱼunction with the instructions stored in the memory. The client application is configured to receive the do not disturb state provided by a hosted service, configure a behavior of the client application based on the do not disturb state, and upon an expiration of the do not disturb state, revert the behavior of the client application.

In other examples, the client application includes one of: a scheduling application, a communication application, a presence application, and a health application.

In some examples, a means for propagating a do not disturb state is described. The means for propagating a do not disturb state includes a means for determining a user's state to be a do not disturb state based on receiving a direct user input of an inference from user associated data, a means for exposing the do not disturb state to a first application consumed by a user and a second application consumed by other user, where the first and second applications are provided by the hosted service, a means for configuring a first behavior of the first application based on the do not disturb state, and a means for upon expiration of the do not disturb state, reverting the first behavior of the first application.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method executed on a computing device to propagate a do not disturb state, the method comprising
determining a user's state to be a do not disturb state based on receiving a direct user input or an inference from user associated data;
exposing the do not disturb state to a first application consumed b a user and a second application consumed by other user, wherein the first and second applications are provided by the hosted service;
configuring a first behavior of the first application based on the do not disturb state; and
upon expiration of the do not disturb state, reverting the first behavior of the first application.

2. The method of claim 1, further comprising:
configuring a second behavior of the second application based on the do not disturb state of the user; and
upon expiration of the do not disturb state, reverting the second behavior of the second application.

3. The method of claim 1, further comprising:
exposing the do not disturb state to other hosted service such that a third behavior of a third application provided by the other hosted service is configured based on the do not disturb state of the user.

4. The method of claim 1, wherein configuring the first behavior of the first application comprises:
one or more of rejecting an incoming communication, providing a silent notification to the user, providing a muted notification to the user, and providing a dimmed notification to the user upon receiving the incoming communication.

5. The method of claim 1, wherein configuring the first behavior of the first application comprises:
rejecting an invitation to schedule a meeting during a duration of the do not disturb state.

6. The method of claim 1, wherein configuring the first behavior of the first application comprises:
storing an incoming communication or an invitation to schedule a meeting received during a duration of the do not disturb state; and
notifying the user regarding the incoming communication or the invitation to schedule the meeting upon an expiration of the do not disturb state.

7. The method of claim 6, wherein the incoming communication includes one of an audio communication, a video communication, an online conference, a text message, an email, a desktop sharing session, and a data sharing session.

8. The method of claim 1, wherein determining the user's state to be the do not disturb state based on the inference from the user associated data comprises:
determining a user behavior associated with personal and work activities; and
inferring the do not disturb state and a duration of the do not disturb state based on the determined user behavior.

9. The method of claim 8, wherein determining the user behavior associated with the personal and work activities comprises:
analyzing a schedule of the user, one or more communications associated with the user, a location of the user, and one or more external factors:

10. The method of claim 1, wherein determining the user's state to be the do not disturb state based on the inference from the user associated data comprises:
analyzing data from a client device rendering the first application.

11. A server configured to propagate a do not disturb state, the server comprising:
a communication module configured to facilitate communication between a hosted service and an application provided by the hosted service on which the do not disturb state is to be configured;
a memory configured to store instructions; and
a processor coupled to the memory and the communication module, the processor executing the hosted service in conjunction with the instructions stored in the memory, wherein the hosted service includes:
an inference module configured to:
determine a user's state to be a do not disturb state based on receiving a direct user input or as interference from user associated data;
a state module configured to:
expose the do not disturb state to the application consumed by a user, wherein the application is provided by the hosted service;
determine an exception that interrupts the do not disturb state during duration of the do not disturb state;
configure a behavior of the application based on the do not disturb state and the exception; and
upon expiration of the do not disturb state, revert the behavior of the application.

12. The server of claim wherein the inference module is further configured to determine the exception with one or more operations to:
receive other direct user input associated with the exception.

13. The server of claim 12, wherein the inference module is further configured to determine the exception with one or more operations to:
determine a user behavior from the user associated data; and
infer the exception for the do not disturb state and the duration of the do not disturb state based on the user behavior.

14. The server of claim 11, wherein the state module is further configured to configure the behavior of the application based on the exception with one or more operations to:
allow an incoming communication to be provided to the user based on the exception, wherein a sender of the communication is detected as one or more of a family member, a supervisor, and a designated sender by the user.

15. The server of claim 11, wherein the state module is further configured to configure the behavior of the application based on the exception with one or more operations to
allow a meeting invitation during the duration of the do not disturb state to be scheduled based on the exception, wherein an invitee of the meeting is detected as one or more of a supervisor and a designated invitee by the user.

16. The server of claim 11, wherein the state module is further configured to:
determine a reason for the do not disturb state; and
one of:
expose the reason for the do not disturb state along with the do not disturb state, and
determine the exception for the do not disturb state based on the reason of the do not disturb state.

17. The server of claim 16, wherein the state module is further configured to:
determine the reason for the do not disturb state based on an analysis of content of one or more of an incoming communication and a scheduled event associated with the user.

18. The server of claim 11, wherein the state nodule is further configured to revert the behavior of the application upon an expiration of the do not disturb state with an operation to:
expose an end of the do not disturb state upon the expiration of the do not disturb state, or
expose a duration of the do not disturb state along with the do not disturb state.

19. A computing device configured to execute a client application that receives a do not disturb state, the computing device comprising:
a memory configured to store instructions; and
a processor coupled to the memory, the processor executing a client application in conjunction with the instructions stored in the memory, wherein the client application is configured to:
receive the do not disturb state provided by a hosted service;
configure a behavior of the client application based on the do not disturb state; and
upon an expiration of the do not disturb state, revert the behavior of the client application.

20. The computing device of claim 19, wherein the client application includes one of: a scheduling application, a communication application, a presence application, and a health application.
